(19) United States
(12) Patent Application Publication
(10) Pub. No.: US 2008/0292945 A1
(43) Pub. Date: Nov. 27, 2008

(54) BATTERY HEATING SYSTEM AND METHODS OF HEATING

(76) Inventors: Ajith Kuttannair Kumar, Erie, PA (US); John Butine, Erie, PA (US)

Correspondence Address: General Electric Company;Global Patent Operation, 187 Danbury Road, Suite 204, Wilton, CT, 06897-4122, US

(21) Appl. No.: 11/752,635

(22) Filed: May 23, 2007

(51) Int. Cl. H01M 10/50

(52) U.S. Cl. 429/52; 429/120

(57) ABSTRACT

A battery includes a plurality of insulated cells electrically interconnected to each other and a heat exchanger disposed above the plurality of cells to heat the battery. A system for transferring energy between a waste heat source and the battery and a method for controlling the temperature of the battery are also disclosed.

### BACKGROUND OF THE INVENTION

### Field of the Invention

The embodiments disclosed relate generally to batteries and more particularly to batteries with improved heating systems and to methods of heating batteries.

In electric vehicles and in hybrid electric vehicles and non-vehicle applications (e.g., locomotives, off-highway mining vehicles, marine applications, cranes, buses, and automobiles), batteries are essential components used to store a portion of the energy that is regenerated during braking for later use during motoring or generated for later use when the demand is low, thus increasing fuel efficiency.

FIG. 1 illustrates an inner assembly 10 of a conventional battery 11 and FIG. 2 shows a cross-sectional view of the conventional battery 11 having the inner assembly 10 of FIG. 1. As illustrated, the inner assembly 10 of the conventional battery 11 includes a base plate 12, also known as a button sheet, having a plurality of buttons or protrusions 13 configured to hold a plurality of cells 14 electrically connected to each other by a plurality of bus bars (not shown). Separating groups of cells 14, a plurality of cooling ducts or plates 16 supplied with air from a cooling header 18 is designed to maintain the cells 14 within a desired operating temperature range.

As it will be apparent to one of ordinary skill, FIG. 1 is presented for the purpose of illustrating components of the conventional battery 11, including only a small number of cells 14 for better clarity of the other features illustrated and described, and should not be considered as limiting the different embodiments of the invention disclosed or as an illustration of a commercial product. For example, in some conventional batteries, different than what is illustrated in FIG. 1, a cooling plate 16 is provided between each two rows of cells 14.

As illustrated in FIG. 2, mica sheets 20 are packed between adjacent cells 14 so as to insulate the cells 14 from each other and from the mechanical packaging of the conventional battery 11. The mechanical packaging of the conventional battery 11 also includes an inner casing 22, which envelops the inner assembly 10, separated from an outer casing 24 by a layer of insulation material 26. Typically, the space between the inner casing 22 and the outer casing 24 is evacuated in order to minimize heat transfer to and/or from the battery.

In general, battery-operating environments are harsh due, at least in part, to large changes in environmental temperature commonly encountered. In addition, charge and discharge are accomplished under severe conditions, including significant changes in battery operating temperatures due to large amounts of discharging current at the time of acceleration of a vehicle and large amounts of charging current at the time of breaking. In addition, optimum performance requires that these batteries be maintained uniformly within a given temperature range, which depends on the type of battery used, thus requiring that cooling and/or heating be provided. Many different types of batteries are known to exits; however, current high-temperature batteries, such as Sodium Nickel Chloride batteries, have to be heated to operating temperatures above 270° C. In the conventional battery 11, cooling is accomplished with airflow through the cooling plates 16, as explained, and an electric heater 28 is provided to raise the temperature of the battery to the desired operating level. As the size of the conventional battery 11 increases, it becomes more difficult to heat the battery uniformly by use of the electric heater 28 and a significant amount of energy must be used. However, electric heating is an inefficient use of energy, thus processes that use regeneration of waste heat for heating purposes have recently received great attention. In the operation of electric and hybrid vehicles, several sources of waste heat exist, but the use of heat regeneration for the purpose of heating a battery is unknown to these authors.

It would therefore be desirable to develop a battery having an improved heating system with increased heat transfer effectiveness, increased heating uniformity and reduced power requirement, among others.

### BRIEF SUMMARY OF THE INVENTION

One or more of the above-summarized needs or others known in the art are addressed by batteries that include a plurality of insulated cells electrically interconnected to each other and a heat exchanger disposed above the plurality of cells to heat the battery.

Batteries according to embodiments of the disclosed inventions also include a plurality of cooling plates, a plurality of cells disposed between cooling plates, a button sheet to support the cells, a plurality of insulating sheets disposed between the cells, a plurality of bus bars electrically interconnecting the plurality of cells, and means for heating the battery.

Embodiments of the disclosed invention are also related to systems for transferring energy to or from a battery. Such systems including: a first heat exchanger having first and second inlets in flow communication with corresponding first and second outlets, a first heat source in flow communication with the second inlet and the second outlet of the first heat exchanger; a second heat exchanger having first and second inlets in flow communication with corresponding first and second outlets, an outlet of a heat exchanger of the at least one battery in flow communication with the first outlets of the first and second heat exchangers, a second heat source in flow communication with the second inlet and the second outlet of the second heat exchanger; a pump having an inlet in flow communication with an outlet of the heat exchanger of the battery; and a diverter valve connected to an outlet of the pump, the diverter valve being configured to selectively direct flow from the outlet of the pump to either the first inlet of the first heat exchanger or the first inlet of the second heat exchanger.

Methods for controlling the temperature of a battery are also within the scope of the disclosed invention. Such methods include the transferring of heat to the battery from a first heat source so that the temperature of the battery increases from an initial temperature to a first threshold value, the first threshold value being lower than an operating temperature range; and the transferring of heat to the battery from a second heat source until the temperature of the battery is within the operating temperature range.

The above brief description sets forth features of the various embodiments of the present invention in order that the detailed description that follows may be better understood, and in order that the present contributions to the art may be better appreciated. There are, of course, other features of the invention that will be described hereinafter and which will be for the subject matter of the appended claims.

In this respect, before explaining several embodiments of the invention in detail, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

Further, the purpose of the foregoing Abstract is to enable a patent examiner and/or the public generally, and especially scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a perspective view of an inner assembly of a conventional battery;

FIG. 2 illustrates a cross-sectional view of a conventional battery having the inner assembly of FIG. 1 taken along a direction perpendicular to the cooling plates;

FIG. 3 illustrates a cross-sectional view of a battery according to an embodiment of the subject matter disclosed;

FIG. 4 illustrates a cross-sectional view of a battery according to another embodiment of the subject matter disclosed;

FIG. 5 illustrates a liquid-circulating cooling plate according to another embodiment of the subject matter disclosed;

FIG. 6 illustrates a liquid-circulating cooling plate according to yet another embodiment of the subject matter disclosed;

FIG. 7 illustrates a diagram of a system for exchanging heat with a battery in accordance with yet another embodiment of the subject matter disclosed;

FIG. 8 is a qualitative graph showing that all the power to heat the conventional battery 11 is provided by the electric heater 28;

FIG. 9 is a qualitative graph illustrating that a portion of the total power needed to heat a battery is provided by waste heat regeneration from a low temperature source according to an embodiment of the subject matter disclosed and the balance is provided by an electric heater;

FIG. 10 is a qualitative graph illustrating that a portion of the total power needed to heat a battery is provided by waste heat regeneration from an intermediate temperature source according to another embodiment of the subject matter disclosed and the balance is provided by an electric heater; and

FIG. 11 is a qualitative graph illustrating that a portion of the total power needed to heat a battery is provided by waste heat regeneration from a high temperature source according to yet another embodiment of the subject matter disclosed and an electric heater provides the balance.

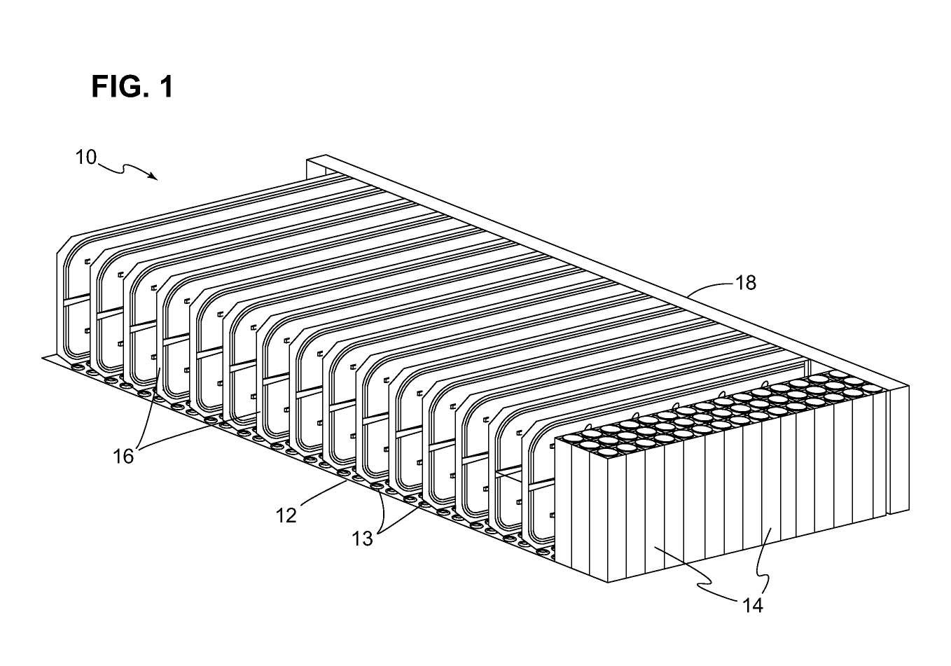

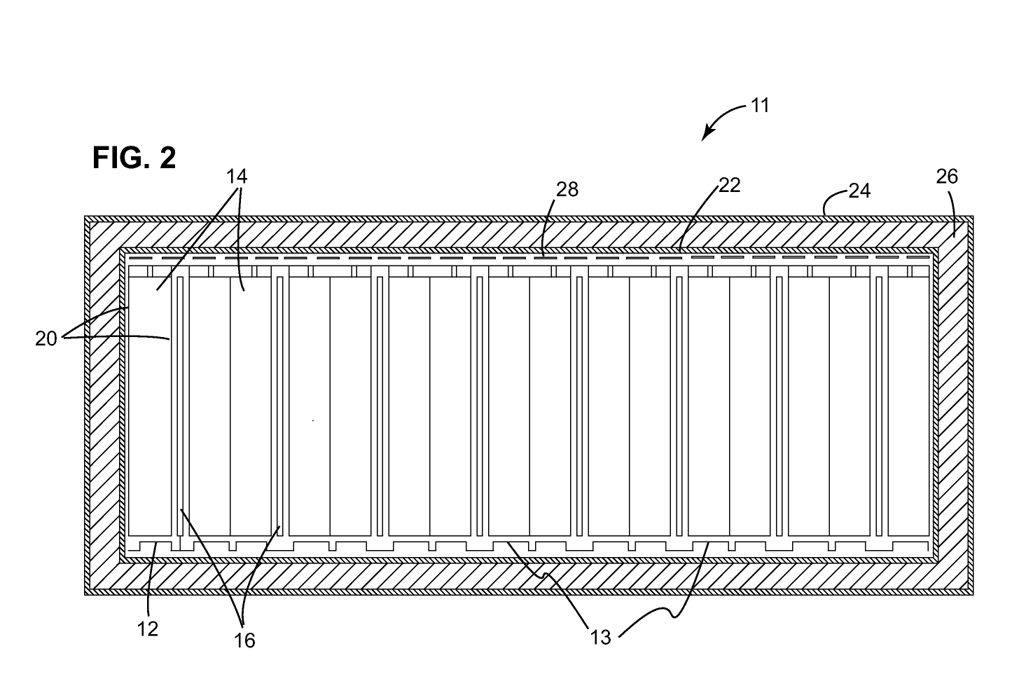

### DETAILED DESCRIPTION OF THE PREFERRED EMBODIMENTS

Embodiments of the subject matter disclosed relate generally to batteries and more particularly to batteries with improved heating and cooling systems and to methods of heating and cooling batteries. By use of waste heat recirculation and/or improved liquid-circulating heat exchangers, improved heat transfer effectiveness, increased heating and/or cooling uniformity, and reduced power requirements are accomplished either individually or in any combination, among other advantageous features, as will be apparent to those of ordinary skill based on the subject matter disclosed. In addition, those of ordinary skill will appreciate that the various embodiments disclosed herein for cooling and/or heating a battery are not dependent on each other, i.e., each may be implemented without the other and various combinations are within the scope of the subject matter disclosed, as it will become apparent. Referring now to the drawings, wherein like reference numerals designate identical or corresponding parts throughout the several views, several embodiments of the improved batteries and heating and/or cooling systems will be described.

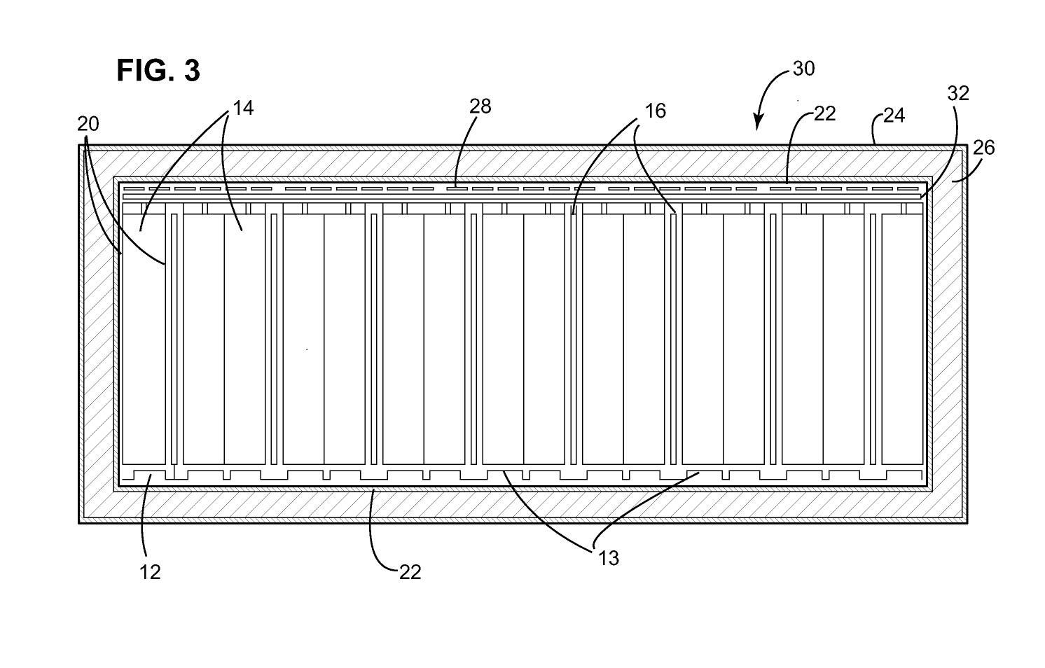

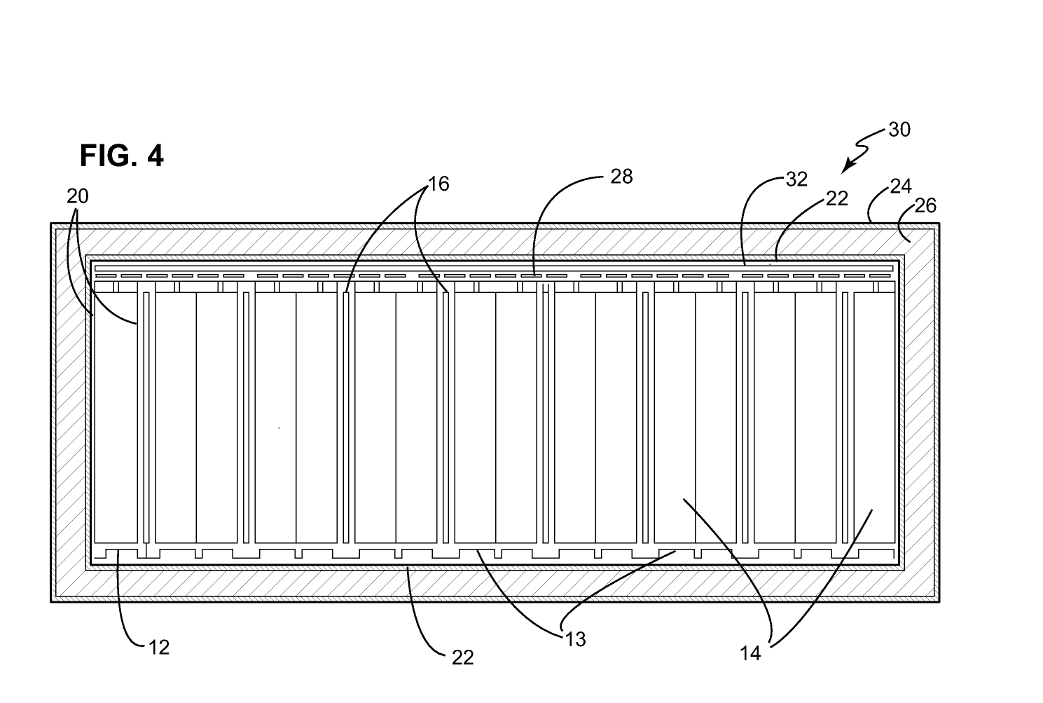

FIGS. 3 and 4 illustrate cross-sectional views of two embodiments of the disclosed subject matter taken in a direction perpendicular to the cooling plates 16. The illustrated embodiments include the base plate 12 with the plurality of buttons or protrusions 13 to hold the plurality of cells 14 electrically connected to each other by the plurality of bus bars (not shown). The embodiments may also include the plurality of cooling ducts or plates 16, separating the groups of cells 14, configured to maintain the cells 14 within a desired operating temperature range. The mica sheets 20 are packed between adjacent cells 14 so as to insulate the cells 14 from each other and from the mechanical packaging. The disclosed embodiments also include the inner casing 22, which is separated from the outer casing 24 by the layer of insulation material 26.

When heat a battery 30, one of the advantageous features of the embodiments illustrated in FIGS. 3 and 4 is a heat exchanger 32 disposed above the cooling plates 16 either below (FIG. 3) or above (FIG. 4) the electric heater 28. Although the battery 30 of FIGS. 3 and 4 is illustrated as including the electric heater 28, heating the battery 30 with only the heat exchanger 32 is also within the scope of the disclosed embodiments. Thus, the heat exchanger 32 is used to provide either all or a portion of the heat needed to bring the temperature of the battery 30 within a desired range for the proper operation. The various possible configurations of the heat exchanger 32 are known in the art. For example, the heat exchanger 32 may have a single inlet and a single outlet; it may be of a single pass or multiple passes, and so forth. In some instances, the heat exchanger 32 may be disposed in other locations within the battery 30 (as for example, but not as a limitation, between the button sheet 12 and the inner casing 22). Thus, while disposition of the heat exchanger 32 in other locations within the battery 30 is contemplated by the various embodiments of the present invention, placement of the heat exchanger 32 on top of the battery 30 is favored so as to minimize interference with the melting process within the cells 14 and to aid the melting process to begin at the top and also to integrate the electrical-heating and waste-heat systems. In addition, the electrical-heating system can also be used to heat the cooling medium used in the heat exchanger or directly heat the heat exchanger, so as to provide uniform heating.

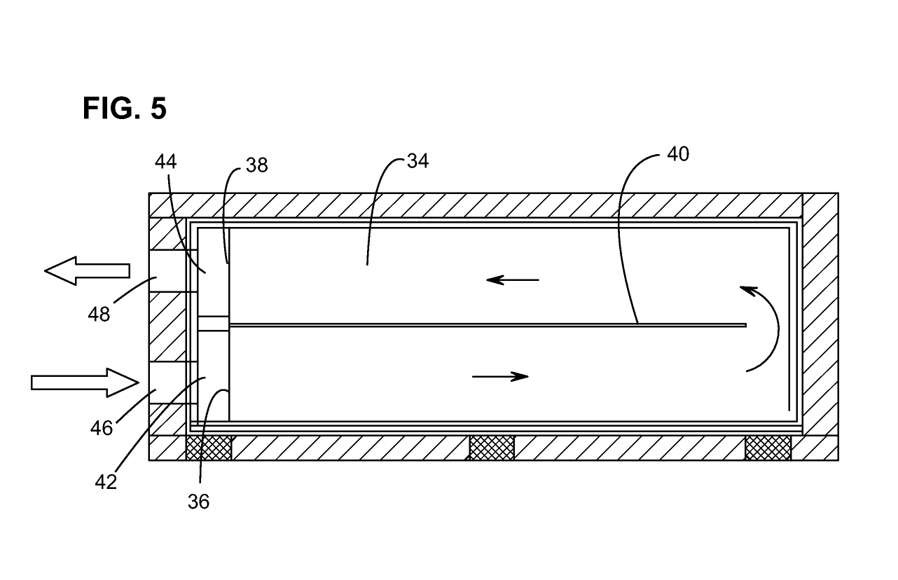

As further explained below, embodiments of the subject matter disclosed may separately or in combination with the exemplary embodiments of FIGS. 3 and 4 include advantageous devices for cooling the battery 30. FIG. 5 illustrates a cross-sectional view of the battery 30 taken along an embodiment of a liquid-circulating cooling plate 34. The liquid-circulating cooling plate 34 includes an inlet 36 and an outlet 38, through which a cooling fluid enters and exits the battery 30 for cooling, and a divider 40. The inlet 36 and the outlet 38 of individual liquid-circulating cooling plates 34 are connected to inlet and outlet distribution manifolds 42 and 44 that are connected outside of the battery 30 to a fluid inlet 46 of the inlet distribution manifold 42 and a fluid outlet 48 of the outlet distribution manifold 44. As shown, the cooling fluid enters the battery 30 through the fluid inlet 46 and is distributed to each liquid-circulating cooling plate 34 by the inlet distribution manifold 42, entering the liquid-circulating cooling plate 34 through its inlet 36 and flowing toward the rear portion of the liquid-circulating cooling plate 34 through a flow passage formed by a bottom portion of the liquid-cooling plate 34 and the divider 40. The fluid is then turned around and flows toward the outlet 38, the outlet distribution manifold 44, and finally the fluid outlet 48. A plurality of liquid-circulating cooling plates 34 is disposed inside the battery 30. As understood by those of ordinary skill in the art, one of the advantageous features of the liquid-circulating cooling plate 34 relates to the enhanced performance of heat transferred to the battery due to the higher heat transfer coefficients of liquids compared to gases. As such, although air, or another gas, may be used to cool the battery 30 through the liquid-circulating cooling plate 34, a liquid is favored due to higher heat transfer capability and uniform temperature capability as well as the increased likelihood of outside air contaminating the battery, thus reducing the need for filtration.

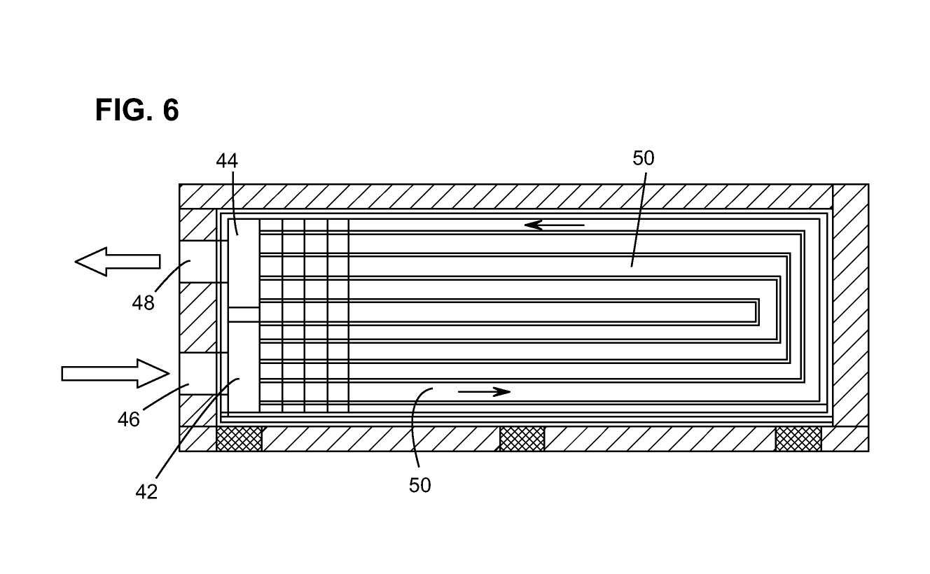

An alternative embodiment of the liquid-circulating cooling plate 34 is shown in FIG. 6. In FIG. 6, a cross-sectional view taken along the liquid-circulating cooling plate 34 is shown. In the embodiment of FIG. 6, the liquid-circulating cooling plate 34 includes a plurality of tubes 50 disposed side by side from the inlet distribution manifold 42 to the outlet distribution manifold 44. Among other advantageous reasons, the use of tubes advantageously accommodates fluid pressures and simpler connections with the manifolds.

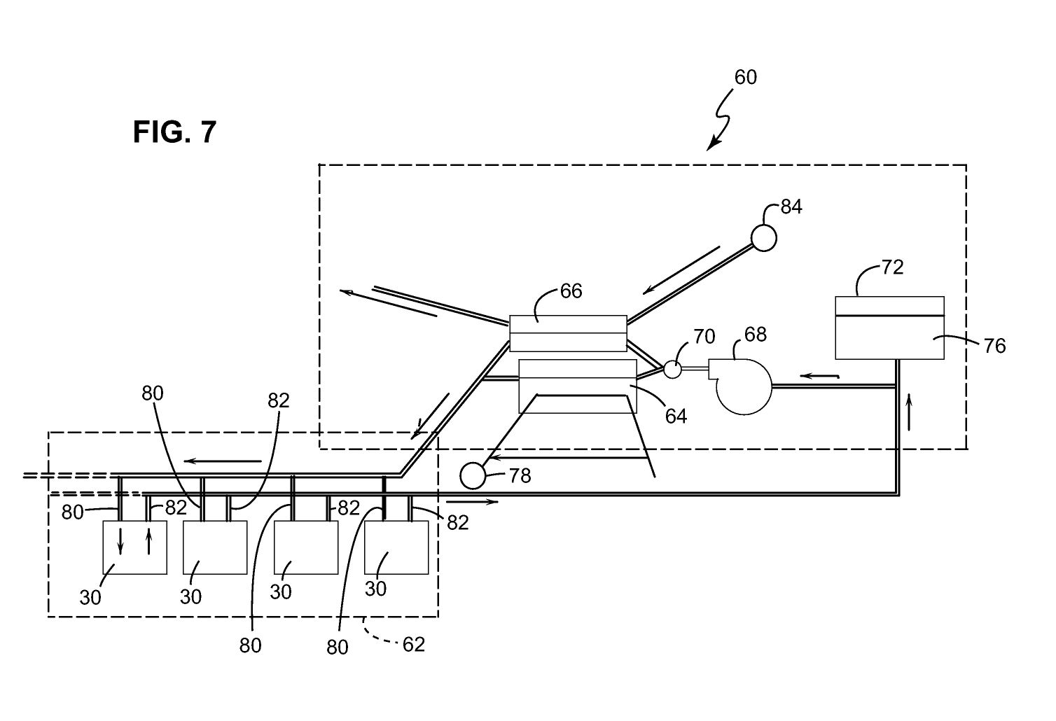

Different sources of waste heat in the vehicle carrying the battery 30 may be used to supply heating and/or cooling to the battery 30. FIG. 7 illustrates an energy transfer system 60 to maintain the temperature of the battery 30 within a prescribed operating range by cooling and/or heating an array of batteries 62 in a electrical or hybrid vehicle (not shown). As used herein, the expression “energy transfer system” is meant to imply that the energy transfer system 60 is configured to either transfer energy from various energy sources to a battery or to remove energy from the battery to the same or other energy sources or sinks, so as to ensure operation of the battery within a desired temperature range. As such, the energy transfer system 60 is configured to cool, heat, and/or cool and heat the battery 30. Applicant's Patent Application with Attorney Docket No. 220176 being concurrently filed relates to the cooling of the battery 30 and that application is incorporated herein by reference in its entirety.

As illustrated, the energy transfer system 60 includes at least two heat exchangers 64 and 66, a pump 68, a diverter valve 70, a fluid reservoir 72, and a plurality of interconnected pipes, as further explained below. As understood by those of ordinary skill in the art, the fluid reservoir 72 is not required for the proper operation of the energy transfer system 60. However, when used, the fluid reservoir 72 may serve as an expansion chamber and a source of make-up fluid. Normally, the energy transfer system 60 is connected to the array of batteries 62. As used herein and appreciated by those of ordinary skill, the word “pipe” encompasses pipes, tubes, channels, and ducts or any other structure for transporting/flowing a fluid and the expression “connected” is used broadly to include direct connection of the different components or the use of valves and other devices (such as flow meters, etc) disposed between the different components interconnected by pipes. In addition, the type of pipe used in its construction does not substantially affect the operation and performance of the energy transfer system 60. Furthermore, although the array of batteries 62 has been illustrated, a single battery 30 may be alternatively used.

In the energy transfer system 60, when heating the array of batteries 62, a fluid 76 from the fluid circulated in the system is pumped by the pump 68 through the heat exchanger 64, where the fluid temperature is raised by heat transfer thereto from a first source 78. Heat from the first source 78 may be from an electric heater powered by an electric power source from the vehicle or may be regenerated from other sources in the vehicle, such as, for example, exhaust gases from an engine in the vehicle or heat generated during dynamic braking of the vehicle. As used herein throughout, dynamic braking relates to a braking force applied by traction motors for controlling speed or for slowing the vehicle down. That is, when a traction motor is not needed to provide a driving force, it can be reconfigured (via power switching devices) so that the motor operates as a generator. In conventional locomotives, for example, the energy generated in the dynamic braking mode is typically transferred to resistance grids mounted on the locomotive housing. Thus, the dynamic braking energy is converted to heat and dissipated from the system. In other words, electric energy generated in the dynamic braking mode is typically wasted in conventional vehicles. The heated fluid 76 from the heat exchanger 64 then flows in and out of the array of batteries 62 through inlets 80 and outlets 82 of the individual batteries 30, thereby heating the individual batteries 30 in the array of batteries 62. As illustrated, after leaving the batteries 30, the fluid 76 returns to the pump 68.

When heating the battery 30, the heat transfer from the fluid 76 to each battery 30 in the array of batteries 62 may take place in several different internal heat exchanges, depending on the configuration of the batteries 30. For example, the fluid flow through each of the batteries 30 may be through the heat exchanger 32 (shown in FIGS. 3 and 4), the liquid-circulating cooling plate 34 (shown in FIGS. 5 and 6), or both. In addition, cooling may also be provided through the conventional cooling plates 16 in combination with the heat exchanger 32 and/or a plurality of liquid-circulating cooling plates 34. As previously explained, on embodiments having an electric heater 28, the heat exchanger 32 may disposed either above or below the heater 28 inside of the inner casing 22. The heat exchanger 32 may be configured as a plurality of ducts or tubes in a flat panel or panels and in flow communication to the fluid inlet and outlet manifolds.

As previously explained, in use, the temperature of the battery 30 may exceed a maximum value of a desired range, thus requiring that cooling be provided so as to maintain the battery operating temperature within the desired range. In the energy transfer system 60, when cooling the array of batteries 62, the fluid 76, after passing through the pump 68, is diverted by the diverter valve 70 into the heat exchanger 66, where its temperature is lowered by heat transfer therefrom to a second source 84. The second source 84 may be cooling water or oil from the vehicle and the heat added thereto may be eventually dissipated in a radiator of the vehicle, for example. Similar to the heating mode, the cooled fluid 76 from the heat exchanger 66 flows in and out of the array of batteries 62 through the inlets 80 and the outlets 82, thereby cooling each of the batteries 30 in the array of batteries 62, and returns to the pump 68. Although other heat exchangers may be used while cooling the battery 30, as understood by those of ordinary skill in the applicable arts, liquid-circulating cooling plates 34 are favored.

As just described during the heating cycle, the heat transfer from the fluid 76 to the batteries 30 in the array of batteries 62 may take place in one or several different internal heat exchangers, depending on the configuration of the individual batteries 30, such as the heat exchanger 32 or a plurality of liquid-circulating cooling plates 34. However, as understood by those of ordinary skill, a plurality of diverter valves may be used in each of the batteries 30 so as to direct the flow of the fluid 76 though a particular heat exchanger for cooling the battery and through a different heat exchanger for heating the battery. For example, the fluid 76 may flow through the heat exchanger 32 for heating and through a plurality of liquid-circulating cooling plates 34. Alternatively, the fluid 76 may flow through both the heat exchanger 32 and the plurality of liquid-circulating cooling plates 34 for both heating and cooling. Although the fluid 76 has been illustrated as being a liquid, alternatively, the fluid 76 may also be a gas, for example, air. As understood by those of ordinary skill, one of the advantageous features of the energy transfer system 60 is its ability to regenerate energy from waste energy sources within the vehicles carrying the batteries 30. In addition, for high-temperature batteries, initial battery heating may be provided by flowing the fluid 76 through the heat exchanger 66 since the temperature of the fluid 76 will be lower than the temperature of the fluid from the second source 84.

In operation, electric vehicles, hybrid-electric vehicles and non-vehicle applications (e.g., locomotives, off-highway mining vehicles, marine applications, cranes, buses and automobiles) have several waste heat sources, the energy from which is simply dissipated to the surrounding environment. In the exemplary case of a locomotive, for example, waste heat is dissipated from the engine cooling water, the engine block, the engine oil, the engine exhaust gases, and from dynamic braking.

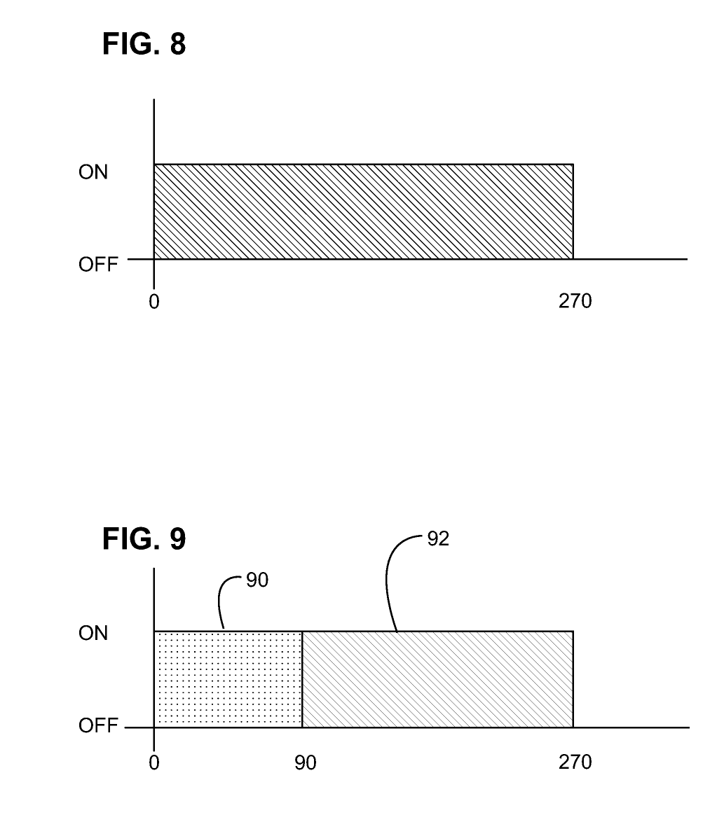

As illustrated in FIGS. 9-11, several of the disclosed embodiments of the instant invention are related to the recirculation of heat from the above-noted waste sources for the purpose of heating a battery. FIG. 8 is included for comparison purposes only, illustrating that, for the conventional battery 11, the electric heater 28, as previously explained, supplies all the energy needed for heating from an initial temperature to an operating temperature of, for example, 270√ C. FIGS. 9-11 illustrate qualitative fractional variations of power supplied to a battery according to different embodiments of the invention using relatively low temperature heat sources (e.g., radiator water, engine oil, and/or engine block), engine exhaust heat, and dynamic braking, respectively. Either a fraction of the energy needed to heat up the battery maybe provided from these waste heat sources, the balance of which being supplied by conventional heaters in the battery (as shown in FIGS. 9-11), or the total energy needed may be supplied from these waste heat sources, depending on the availability of waste heat, the temperature of the waste heat and the operating temperature to which the battery need to be heated. As it will be understood by those of ordinary skill, although the embodiments of the invention discussed herein are presented as they apply to a hybrid locomotive, other applications, such as, but not being limited to electric vehicles, hybrid-electric vehicles, and non-vehicle applications (e.g., off-highway mining vehicles, marine applications, cranes, buses and automobiles), are also within the scope of the disclosed invention.

In the illustration of FIG. 9, a first portion 90 of the total energy needed to heat the hybrid battery is provided by recirculating at least a portion of a relatively low temperature waste heat from the engine cooling water, the engine block, or the engine oil (heating the battery to an exemplary temperature of 90° C.); the balance, as indicated by a second portion 92, is provided from a conventional heater (to heat the battery to an exemplary operating temperature of 270° C.). In use, heat may be transferred directly to the battery by circulating the engine cooling water, a fluid in contact with the engine block, or the engine oil through the cooling plates 16 or by circulating these fluids through the energy transfer system 60 and the heat exchanger 32 and/or the liquid-circulating cooling plates 34 to transfer heat from the waste fluid stream to the battery 30. As those of ordinary skill in the applicable arts will understand it, the temperatures of 90 and 270° C. are exemplary in nature and should not be considered as limiting the disclosed inventions in any way. For example, if the engine cooling fluid is at 90° C., for example, as illustrated, the first portion 90 brings the battery to that intermediate temperature. As understood by those of ordinary skill, this intermediate temperature will depend on the type of waste heat being recirculated. For example, radiator fluid is usually at a temperature slightly below the fluid boiling point at the applicable saturation pressure, thus, if the radiator fluid were non-pressurized water, the intermediate temperature would be around 90° C. However, the disclosed invention is not limited to an intermediate temperature of 90° C. As understood by those of ordinary skill, most vehicle radiator systems employ pressurization and the radiator fluid is close to 100° C.

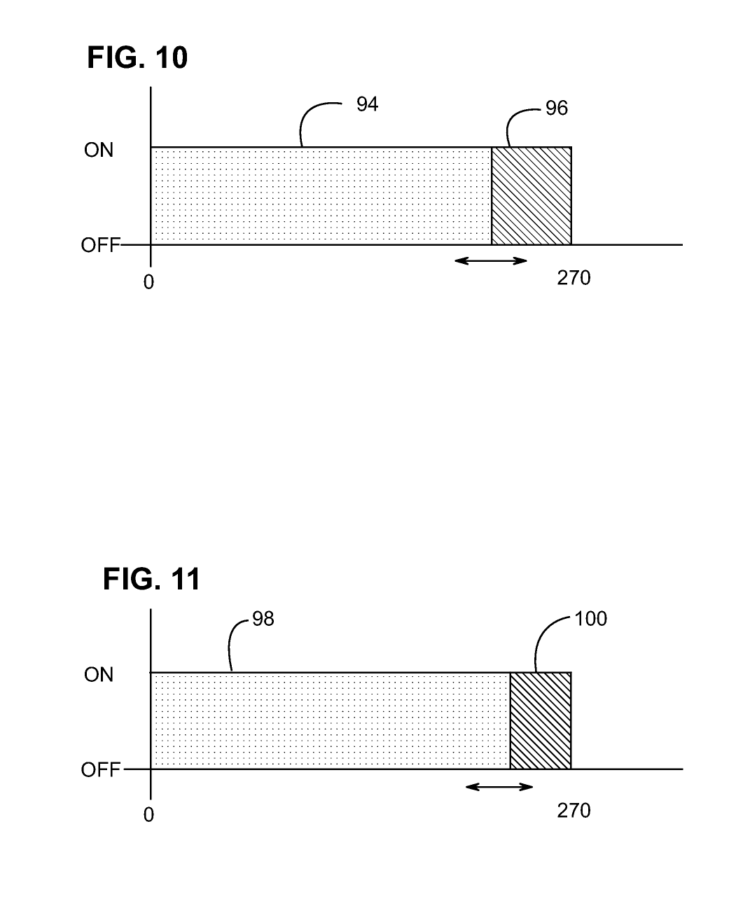

In the illustration of FIG. 10, a higher temperature waste heat source, e.g., the engine exhaust heat, is used for recirculation. As such, recirculating at least a portion of the engine exhaust heat provides a first portion 94 of the total energy needed to heat the battery and the balance, as indicated by a second portion 96 of FIG. 10, is provided from a conventional heater. Similarly to the embodiment of FIG. 9, In use, heat may be transferred directly to the battery by circulating the engine exhaust gas through the cooling plates 16 or by circulating the exhaust gas through the energy transfer system 60 and the heat exchanger 32 and/or the liquid-circulating cooling plates 34 to transfer heat from the waste fluid stream to the battery 30. As illustrated, since the engine exhaust stream is normally at a temperature higher that the heat sources for the embodiment of FIG. 9, the first portion 94 brings the battery to a correspondingly higher intermediate temperature, thus reducing the need for additional heat from conventional heaters.

The illustration of FIG. 11 corresponds to the use of heat generated by use of electric power produced during dynamic braking as a waste heat source. As such, a first portion 98 of the total energy needed to heat the hybrid battery is provided by recirculating at least a portion of the heat generated during dynamic braking and the balance, as indicated by a second portion 100 of FIG. 11, is provided from a conventional heater. In use, air flowing through the cooling plates 16 may be first passed over the resistors used to dissipate the energy generated during dynamic braking so as to circulate a portion of that energy to the battery. Otherwise, separate heat exchanger(s) may be used as previously described in conjunction with the embodiments of FIGS. 9 and 10. In the case of energy from dynamic brake, multiple electrical heaters (heaters capable of multiple voltage) may also be used so as to allow the dynamic brake voltage to be applied directly to the heater or to another set of electrical heaters in the same location.

Methods for controlling the temperature of a battery are also within the scope of the subject matter disclosed herein. Such methods include: the transferring of heat to a battery from a first heat source so that the temperature of the battery increases from an initial temperature to a first threshold value, the first threshold value being lower than an operating temperature range or when the first heat source is available; and the transferring of heat to the battery from a second heat source until the temperature of the battery is within the operating temperature range. Once the battery temperature is above the desired range, the disclosed systems are configured to transferring the heat from the battery to the first heat source. The first heat source is selected from the group consisting of water from a radiator of an engine of a vehicle that includes the battery, oil from the engine, heat from a block of the engine, exhaust gas from the engine, dynamic braking from the vehicle, and combinations thereof and the second heat source includes an electric heater. As explained hereinabove, the transferring of heat to the battery from the first heat source includes flowing a liquid through a liquid-circulating heat exchanger within the battery and the transferring of heat from the battery to the first heat source when the temperature of the battery is above the operating temperature range includes flowing a liquid through a plurality of liquid-circulating cooling plates within the battery.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. In addition, the order or sequence of any process or method steps may be varied or re-sequenced according to alternative embodiments. Finally, in the claims, any means-plus-function clause is intended to cover the structures described herein as performing the recited function and not only structural equivalents, but also equivalent structures.

What is claimed is:

1. A battery, comprising:
a plurality of insulated cells electrically interconnected to each other; and
a heat exchanger disposed above the plurality of cells to heat the battery.

2. The battery according to claim 1, wherein a fraction of the energy to raise a temperature of the battery to an operating level is provided from a waste heat source.

3. The battery according to claim 2, wherein the fraction of energy is transferred to the battery through the heat exchanger.

4. The battery according the claim 3, wherein the heat exchanger is a liquid-circulating heat exchanger.

5. The battery according to claim 4, further comprising a plurality of liquid-circulating cooling plates, the plurality of insulated cells being disposed between the plurality of liquid-circulating cooling plates.

6. The battery according to claim 2, further comprising:
an electric heater configured to provide a balance of the energy to raise the temperature of the battery to the operating level; and
an inner casing enclosing the plurality of insulated cells and the heat exchanger, wherein the electric heater is disposed between the inner casing and the plurality of cells.

7. The battery according to claim 2, wherein the waste heat source is selected from the group consisting of water from a radiator of an engine of a vehicle comprising the battery, oil from the engine, heat from a block of the engine, exhaust gas from the engine, dynamic braking from the vehicle, and combinations thereof.

8. A system for transferring energy to or from at least one battery, the system comprising:
a first heat exchanger having first and second inlets in flow communication with corresponding first and second outlets, a first heat source in flow communication with the second inlet and the second outlet of the first heat exchanger;
a second heat exchanger having first and second inlets in flow communication with corresponding first and second outlets, an outlet of a heat exchanger of the at least one battery in flow communication with the first outlets of the first and second heat exchangers, a second heat source in flow communication with the second inlet and the second outlet of the second heat exchanger;
a pump having an inlet in flow communication with an outlet of the heat exchanger of the at least one battery; and
a diverter valve connected to an outlet of the pump, the diverter valve being configured to selectively direct flow from the outlet of the pump to either the first inlet of the first heat exchanger or the first inlet of the second heat exchanger.

9. The system according to claim 8, the at least one battery, comprising:
a plurality of insulated cells electrically interconnected to each other, wherein the heat exchanger is disposed above the plurality of cells to heat the at least one battery.

10. The system according to claim 8, wherein the diverter valve directs flow to the first inlet of the second heat exchanger, and energy from the second heat source is transferred to the at least one battery through the second heat exchanger to heat the at least one battery through the heat exchanger thereof.

11. The system according to claim 10, wherein the diverter valve directs flow to the first inlet of the first heat exchanger, and energy from the at least one battery is transferred to the first heat source through the first heat exchanger to cool the at least one battery through the heat exchanger thereof.

12. The system according to claim 10, wherein the diverter valve directs flow to the first inlet of the first heat exchanger, and energy from the first heat source is transferred to the at least one battery through the first heat exchanger to heat the at least one battery through the heat exchanger thereof.

13. The system according to claim 8, wherein the second heat source comprises an exhaust gas from a vehicle that includes the at least one battery.

14. The system according to claim 8, wherein the second heat source comprises an electric heater powered by dynamic braking of a vehicle that includes the at least one battery.

15. The system according to claim 12, wherein the first heat source is selected from the group consisting of water from a radiator of an engine of a vehicle that includes the at least one battery, oil from the engine, heat from a block of the engine, and combinations thereof and the second heat source is selected from the group consisting of exhaust gas from the engine, dynamic braking from the vehicle, and combinations thereof.

16. The system according to claim 10, wherein the second heat source is selected from the group consisting of exhaust gas from the engine, dynamic braking from the vehicle, and combinations thereof.

17. The system according to claim 11, wherein the first heat source is selected from the group consisting of water from a radiator of an engine of a vehicle that includes the at least one battery, oil from the engine, heat from a block of the engine, and combinations thereof.

18. The system according to claim 11, wherein the heat exchanger comprises a plurality of liquid-circulating cooling plates within the battery.

19. The system according to claim 15, wherein a fraction of the energy to raise a temperature of the battery to an operating level is provided from the first heat source or the second heat source and a balance of the energy is provided by an electric heater within the battery.

20. A battery, comprising:
a plurality of cooling plates;
a plurality of cells disposed between the plurality of cooling plates;
a button sheet having a plurality of buttons to support the plurality of cells;
a plurality of insulating sheets disposed between the plurality of cells;
a plurality of bus bars, the plurality of cells being electrically interconnected by the plurality of bus bars; and
means for heating the battery.

21. A method for controlling the temperature of a battery, the method comprising:
transferring heat to the battery from a first heat source so that the temperature of the battery increases from an initial temperature to a first threshold value, the first threshold value being lower than an operating temperature range; and
transferring heat to the battery from a second heat source until the temperature of the battery is within the operating temperature range.

22. The method according to claim 21, further comprising:
transferring heat from the battery to the first heat source when the temperature of the battery is above the operating temperature range.

23. The method according to claim 22, wherein the first heat source is selected from the group consisting of water from a radiator of an engine of a vehicle that includes the battery, oil from the engine, heat from a block of the engine, exhaust gas from the engine, dynamic braking from the vehicle, and combinations thereof.

24. The method according to claim 23, wherein the second heat source comprises an electric heater.

25. The method according to claim 21, wherein the transferring heat to the battery from the first heat source comprises flowing a liquid through a liquid-circulating heat exchanger within the battery.

26. The method according to claim 22, wherein the transferring heat from the battery to the first heat source when the temperature of the battery is above the operating temperature range comprises flowing a liquid through a plurality of liquid-circulating cooling plates within the battery.
